(19) United States
(12) Patent Application Publication
(10) Pub. No.: US 2010/0111101 A1
(43) Pub. Date: May 6, 2010

(54) METHOD AND SYSTEM FOR MANAGING CONTENT FOR ACCESS DURING A MEDIA SESSION

(75) Inventors: Martin W. McKee, Herndon, VA (US); Paul T. Schultz, Colorado Springs, CO (US); Robert A. Sartini, Colorado Springs, CO (US)

Correspondence Address: VERIZON;PATENT MANAGEMENT GROUP, 1320 North Court House Road, 9th Floor, ARLINGTON, VA, 22201-2909, US

(73) Assignee: Verizon Business Network Service Inc., Ashburn, VA (US)

(21) Appl. No.: 12/266,151

(22) Filed: Nov. 6, 2008

(51) Int. Cl. H04J 3/22

(52) U.S. Cl. 370/466

(57) ABSTRACT

An approach is provided for managing content for access during a media session. Content or information relating to the content is received from a user over a data network. A message is generated, according to an application layer protocol, specifying an address for subsequent retrieval, by the user, of the content over a communication session established over the data network utilizing the application layer protocol.

### BACKGROUND INFORMATION

Telecommunications service providers are migrating towards data-based (e.g., Internet Protocol (IP)-based) solutions for media session delivery such as voice and video calls. To help achieve this migration, many service providers have implemented a telecommunications network architecture using standards-based application layer protocols. For instance, the 3rd Generation Partnership Project (3GPP), a collaborative group of telecommunication associations, has adopted the Session Initiation Protocol (SIP) as the standard signaling protocol used for setting up and tearing down data-based media sessions. However, while a SIP-based media delivery architecture can readily handle voice and video media, the same network architecture cannot easily handle media sessions that include other content such as application documents (e.g., Microsoft PowerPoint® documents) and/or other Internet-based media formats (e.g., Adobe Flash® media). This shortcoming can become a significant problem because modern communications are increasingly dependent on the real-time delivery of a wide variety of content to facilitate collaboration and the exchange of ideas during a communication session.

In parallel, telecommunications service providers are continually challenged to leverage existing infrastructure to provide new services and features to remain efficient and competitive.

Therefore, there is a need for an approach that provides for management of a wide variety of content (e.g., application documents and other media formats) for access during a media session while promoting a uniform approach to session management and media delivery.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of managing media content for access during a media session, according to an exemplary embodiment;

FIG. 2 is a diagram of the components of a content manager platform, according to an exemplary embodiment;

FIG. 3 is a flowchart of a process for managing content for access during a media session, according to an exemplary embodiment;

FIGS. 4A and 4B are, respectively, a diagram of an exemplary protocol used in the system of FIG. 1, and a ladder diagram of a process for accessing content using the exemplary protocol, according to various exemplary embodiments;

FIGS. 5A and 5B are flowcharts of processes for utilizing a content manager platform, according to various exemplary embodiments;

FIGS. 6A-6C depict exemplary graphical user interfaces (GUIs) for using a portal to access a content manager, according to various embodiments;

FIG. 7 is a flowchart of a process for playing back content during a media session, according to an exemplary embodiment; and

FIG. 8 is a diagram of a computer system that can be used to implement various exemplary embodiments.

### DESCRIPTION OF THE PREFERRED EMBODIMENT

A preferred apparatus, method, and system for managing media content for access during a media session are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although the present invention is discussed with respect to the Session Initiation Protocol (SIP), it should be appreciated that one of ordinary skill in the art would recognize that the present invention has applicability to other equivalent communication protocols.

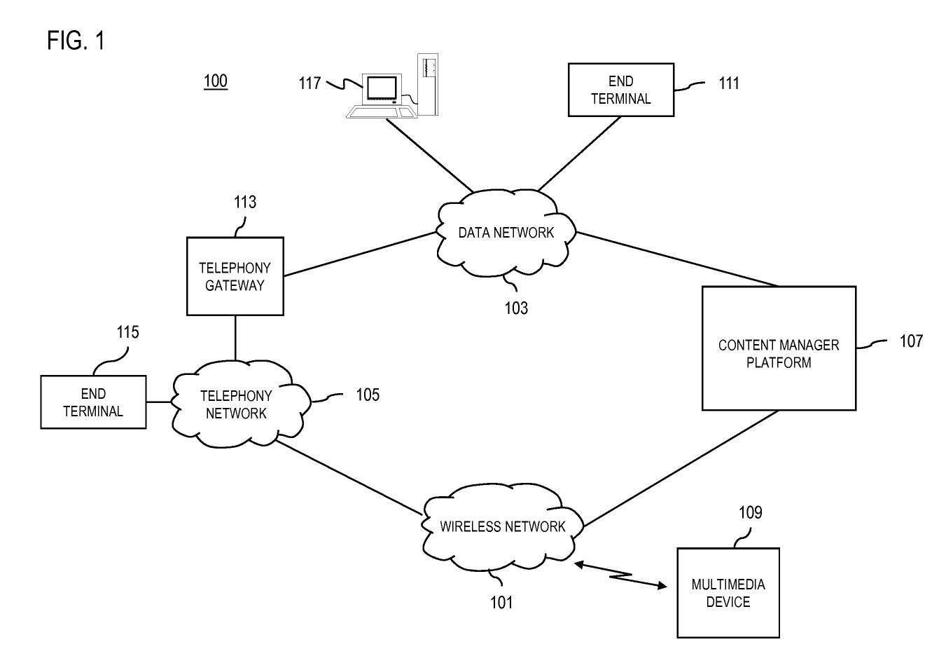

FIG. 1 is a diagram of a system capable of managing content for access during a media session, according to an exemplary embodiment. For the purposes of illustration, a mechanism for managing content for access during a media session is described with respect to a communication system 100 that includes a wireless network 101, a data network 103, and a telephony network 105. These networks 101-105 can support various media sessions, e.g., voice, video, data, etc. A content manager platform 107 provides a capability to manage and store content for access during these media sessions. As shown, the platform 107 resides within the network side. In addition (or alternatively), the content manager platform 107 may reside within customer premises equipment (CPE) (not shown). Specifically, the content manager platform 107 enables the integration of user-specified content (e.g., application documents, Internet-based media, etc.) with service provider-managed media sessions by storing and converting the content into a format appropriate for delivery by existing standards-based network architecture (e.g., IP Multimedia Subsystem (IMS) architecture).

It is contemplated that the wireless network 101 may be, for example, a cellular network and may employ various technologies including code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like. In addition, the data network 103 may be any local area network (LAN), metropolitan area network (MAN), wide area network (WAN), the Internet, or any other suitable packet-switched network, such as a commercially owned, proprietary packet-switched network, e.g., a proprietary cable or fiber-optic network.

With respect to voice calls over the data network 103 (which can be an Internet Protocol (IP) network), four possible scenarios exist with the placement of a Voice Over IP (VOIP) call: (1) phone-to-phone, (2) phone-to-PC, (3) PC-to-phone, and (4) PC-to-PC. In the first scenario of phone-to-phone call establishment, a voice station is switched through the telephony network 105 by a switch to a VOIP gateway (e.g., gateway 113), which forwards the call through the IP network 103. Under the second scenario, a voice station places a call to a PC through a switch to the telephony network 105. The third scenario involves a PC that places a call to a voice station. Using a voice encoder, the PC introduces a stream of voice packets into the IP network 103 that are destined for the VOIP gateway 113. The VOIP gateway 113 converts the packetized voice information into a POTS (Plain Old Telephone Service) electrical signal, which is circuit switched to the voice station. Lastly, in the fourth scenario, a PC establishes a voice call with a PC; in this case, packetized voice data is transmitted from the PC via the IP network 105 to another PC, where the packetized voice data is decoded. Actual endpoints for PC or phone clients may also include different physical devices, such as a television, etc.

The system 100, in one embodiment, employs the Session Initiation Protocol (SIP) to exchange messages. A detailed discussion of SIP and its call control services are described in IETF RFC 2543, IETF RFC 3261 and IETF Internet draft “SIP Call Control Services”, Jun. 17, 1999; these documents are incorporated herein by reference in their entireties. SIP messages are either requests or responses. The end terminal 115 can be a user agent that behaves as either a user agent client (UAC) or a user agent server (UAS), depending on the services that the system 100 is executing. In general, a user agent client issues requests, while a user agent server provides responses to these requests. In the system 100 of FIG. 1, the gateway 113 can be a user agent server.

SIP defines various types of requests, which are also referred to as methods. The first method is the INVITE method, which invites a user to a conference. The next method is the ACK method, which provides for reliable message exchanges for invitations in that the client is sent a confirmation to the INVITE request. That is, a successful SIP invitation includes an INVITE request followed by an ACK request.

Another method is a BYE request, which indicates to the UAS that the session should be released. In other words, BYE terminates a connection between two users or parties in a conference. The next method is the OPTIONS method; this method solicits information about capabilities and does not assist with establishment of a session. Lastly, the REGISTER provides information about a user's location to a SIP server.

According to one embodiment, the system 100 provides delivery of media sessions using an IP-based approach. Specifically, the system 100 uses a signaling protocol (e.g., SIP) in conjunction with a standard data packet format (e.g., Real-time Transport Protocol (RTP)) to deliver communication services. More specifically, the signaling protocol is used to establish, modify, and terminate a media session, while the standard data packet format serves as the conduit for carrying audio and video over a data network. An example of this architecture is the IMS platform which uses SIP and RTP to deliver media sessions.

While this architecture can readily handle voice and video calls, there are a wide variety of other content formats (e.g., application documents and Internet-based media formats). For example, a user may want to share a PowerPoint® presentation or a Flash® animation over a video conference mediated by the IMS architecture. By contrast, the traditional IMS architecture would not be able to handle either the PowerPoint® file or the Flash® animation because the files are in a format that cannot be delivered by the SIP/RTP combination. Instead, the service provider would have to provide means that are external to the traditional IMS architecture to support these files, which can potentially increase the complexity and costs associated with supporting the file formats.

To address this problem, the content manager platform 107 may, for example, receive content from a user via upload or a network link, convert the content to a format compatible with the service provider's media delivery architecture, publish the converted content for subsequent access, generate a message specifying an address (e.g., a SIP Universal Resource Identifier (URI)) for the converted content, and transmit the address to the user. The user and any other authorized parties may then use the transmitted address to access the converted content using a standards-compliant communication device (e.g., a SIP-based video conferencing device) to access the content. The content manager platform 107 also enables the user to control playback of the content (e.g., rewind, pause, fast forward) when accessing the content. In this way, the content manager platform 107 enables the integration of a wide variety of content with media sessions conducted using standards-based media delivery architecture (e.g., IMS architecture). In particular, the platform 107 bridges the gap between media delivery by a telecommunication service provider and media delivery by other means such as the Internet and application software.

As seen in FIG. 1, the content manager platform 107 is connected to a multimedia device 109 (e.g., mobile device, or handset) via a cellular gateway (not shown) over a wireless network 101. The multimedia device 109 may, for instance, provide access to the services and functions of the content manager platform 107. The content manager platform 107 also has connectivity to a data network 103 that supports an end terminal 111. End terminal 111 may be any computing device (e.g., Personal Digital Assistant (PDA), personal computer, laptop, etc.) or communication device (e.g., a Voice over Internet Protocol (VOIP) station, a video conferencing terminal, a digital home communication terminal (DHCT), a television set-top box (STB)) capable of providing access to the services and functions of the content manager platform 107 and supporting communication sessions over the data network 103.

In addition, the content manager platform 107 has connectivity to a telephony network 105 through data network 103 and a telephony gateway 113. In this example, the telephony network 105 can serve an end terminal 115, which may provide access to the services of the content manager platform 107 and include a voice station for initiating a voice call to other end terminals capable of supporting the voice call. End terminal 115 may, for example, include a home communication terminal (HCT), and other telephonic devices, with connectivity to a Public Switched Telephone Network (PSTN), which may be a part of the telephony network 105.

The data network 103 additionally permits a host 117 to access content manager platform 107 services and functions via a graphical user interface (GUI) such as a browser application or any web-based application for multimedia device 109, end terminal 111, and/or end terminal 115. Under one scenario, it is contemplated that a user can configure content manager services, functions, and preferences for multimedia device 109, end terminal 111, and/or end terminal 115 using the host 117 via a web browser.

In one embodiment, the content manager service is a managed service, whereby a service provider operates the platform 107 to serve one or more subscribers.

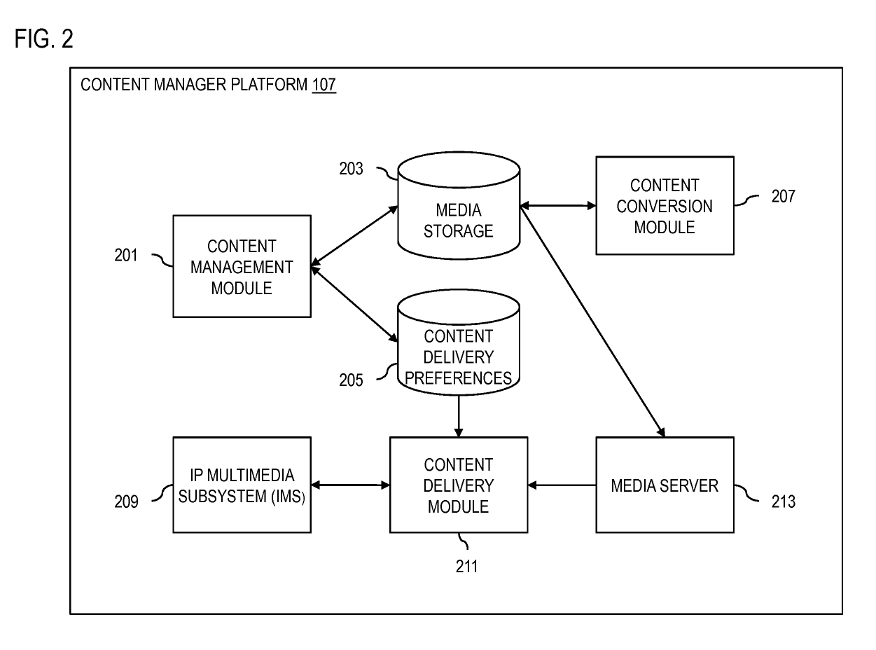

FIG. 2 is a diagram of the components of a content manager platform, according to an exemplary embodiment. By way of example, the content manager platform 107 may include one or more of the modules and/or databases to manage content for access during a media session. A content management module 201 receives user-specified content and directs the content to other modules for storage, conversion, and delivery. In addition, the content management module 201 may have connectivity to a media storage database 203 and a database 205 of content delivery preferences. The media storage database 203 stores content as received from the user as well as any converted form of the content. The content delivery preferences database 205 stores the user's conversion parameters (e.g., media type, size, etc.) and delivery preferences such as when and to whom the content should be made available.

The content conversion module 207 couples to the media storage database 203 and may be used to selectively convert content to a format appropriate for the media delivery architecture (e.g., IMS architecture) used by the network service provider. Although module 207 is depicted as a separate module in FIG. 2, it is contemplated that the conversion module 207 may be a component of IMS platform 209. For instance, the media resource function (not shown) of the IMS platform 209 may perform the conversion function. The media resource function of the IMS platform 209 may include a voice recognition media resource, a text-to-speech media resource, and/or a video mixing/overlay/closed captioning media resource to convert content to a format suitable for delivery via a standards-based network architecture.

For example, the voice recognition media resource may translate speech-based content into text. Namely, the voice recognition media resource is configured to convert spoken language into textual form by extracting meaning from the user's spoken utterances and producing semantic information in the form of text. The text-to-speech media resource may convert text into speech and also can be used to convert meta-data descriptions contained in arriving multimedia streams to speech. The video mixing/overlay/closed captioning resource may present content as a textual pop-up window or other form of text output on the display of the user's communication device. If the media session is video-based (e.g., video communications or multimedia conferencing) or the communication device is video-capable, the video mixing/overlay/closed captioning resource can insert requested content directly into a video stream that is presented on a specified communication device as a video overlay or as closed captioning.

In addition to the IMS platform 209 discussed above, other modules of the content manager platform 107 may include the content delivery module 211 and media server 213. In exemplary embodiments, the IMS platform 209 provides the signaling and media session controls to respond to a user's request for content stored in the content manager platform 107. Specifically, the IMS platform 209 can detect the initiation of a media session requesting specific content and direct this request to the content delivery module 211. The content delivery module 211 then, for instance, may interact with the media server 213 to deliver the requested content according to the user's content delivery preferences stored in database 205. The media server 213 is responsible for retrieving the requested content from the media storage database 203. During content delivery, the content delivery module 211 also enables user control of the content play back (e.g., rewind, pause, fast forward).

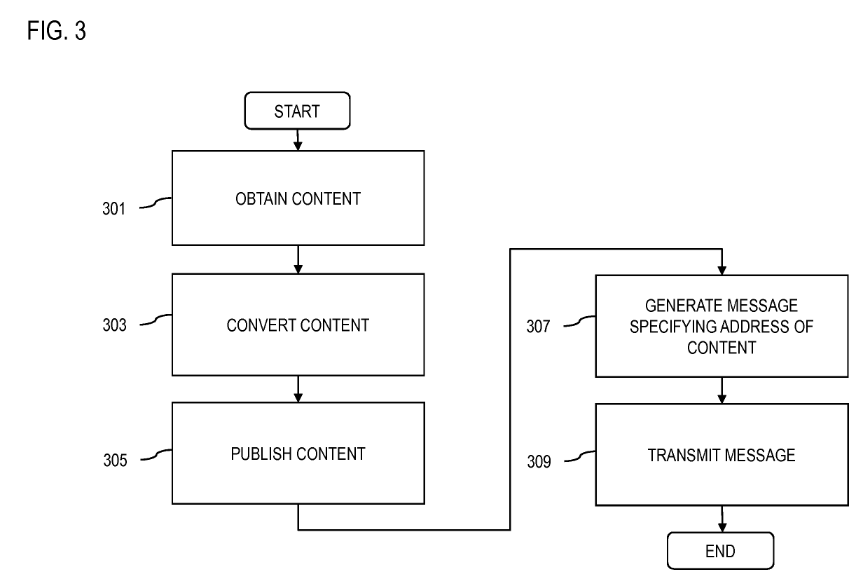

FIG. 3 is a flowchart of a process for managing content for access during a media session, according to an exemplary embodiment. In step 301, the content manager platform 107 receives content or information relating to the content (e.g., URL for the content) from a user. The content may be any electronic media and include application documents (e.g., presentations, word processing documents, spreadsheets), digital photo streams, and Internet-based media formats (e.g., Adobe Flash®, Microsoft Silverlight®). The user may provide an actual electronic file of the document or a network link to the document (e.g., a Hypertext Transport Protocol Universal Resource Identifier (HTTP URI) corresponding to the content). If a file of the content is provided, the content manger platform 107 stores a copy of the content in the media storage database 203. If a link is provided, the content manager platform may either store the link or retrieve a copy of the content to store in media storage database 203.

Once the content is in the database 203, the content manager platform 107 may convert the content to a format compatible with the service provider's media delivery architecture (step 303). For example, the content manager platform 107 may convert the received content (e.g., a PowerPoint® presentation) from a document format into a SIP/RTP-compliant video stream using the content conversion module 207. The content manager platform 107 may then publish the converted content for subsequent access by storing the converted content in media storage database 203 and specifying a SIP Uniform Resource Identifier (URI) for the content (step 305). Under SIP, the SIP URI provides an addressing scheme that is effectively a user's SIP phone number, and resembles an e-mail address. For instance, the format is as follows: sip:x@y:Port (where x is the Username, and y is the host (domain or IP). SIP URI is more fully detailed in Internet Engineering Task Force (IETF) Request for Comment (RFC) 3261, which is incorporated herein by reference in its entirety.

In step 307, the content manager platform 107 generates a message specifying the address (e.g., SIP URI) of the content and transmits the message to the user and any other parties specified by the user (step 309). The content is then accessible by simply placing a call (i.e., establishing a media session) with the specified SIP URI.

The following sample cases illustrate the functions of the content manager platform 107. In the first sample use case, a user has produced a presentation with Microsoft PowerPoint® that the user wants to share over a SIP-based video conference. In preparation for the conference, the user uploads the PowerPoint® presentation to the content manager platform 107. The platform 107 converts and generates a SIP URI for the presentation. The user can then add the SIP URI to the user's video conference which will stream a media session containing the presentation content.

In a second sample use case, the user has identified a Adobe Flash®-based video on a website that the user wants to share over a SIP-based video session. The user specifies the URL for the video on the content manager platform 107. The platform 107 converts the video and generates a corresponding SIP URI. The user can then add the SIP URI to the user's video session which will stream the contents of the video.

In a third sample use case, the user has a set of digital photos the user wants to share over a SIP-based video session. The user uploads the photos to the content manager platform 107. The platform 107 converts the set of photos to a video stream slide show and generates a corresponding SIP URI. The user can then add the SIP URI to the user's video session which will stream the slide show of the photos.

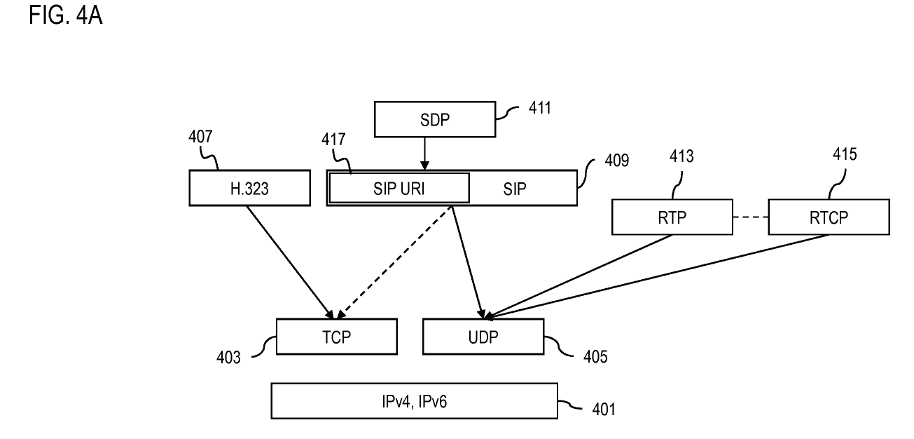

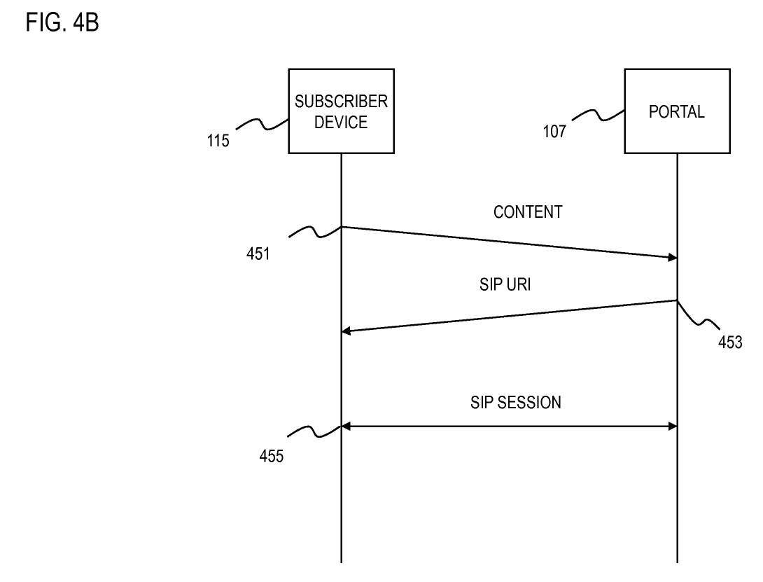

FIGS. 4A and 4B are, respectively, a diagram of an exemplary protocol used in the system of FIG. 1, and a ladder diagram of a process for accessing content using the exemplary protocol, according to various exemplary embodiments. The layered nature of the architecture of FIG. 4A provides protocol separation and independence, whereby one protocol can be exchanged or modified without affecting the other higher layer or lower layer protocols. It is advantageous that the development of these protocols can occur concurrently and independently.

The foundation of the architecture rests with the IP layer 401. The IP layer 401 provides an unreliable, connectionless data delivery service at the network level. The service is “unreliable” in the sense that the delivery is on a “best effort” basis; that is, no guarantees of packet delivery are made. IP is the de facto Internet working protocol standard. Current standards provide two versions of IP: Version 4 and Version 6. One of the key differences between the versions concerns addressing; under Version 4, the address fields are 32 bits in length, whereas in Version 6, the address field has been extended to 128 bits.

Above the IP layer 401 are the TCP (Transmission Control Protocol) 403 and the UDP (User Datagram Protocol) 405. The TCP layer 403 provides a connection-oriented protocol that ensures reliable delivery of the IP packets, in part, by performing sequencing functions. This sequencing function reorders any IP packets that arrive out of sequence. In contrast, the User Datagram Protocol (UDP) 405 provides a connectionless service that utilizes the IP protocol 401 to send a data unit, known as a datagram. Unlike TCP 403, UDP 405 does not provide sequencing of packets, relying on the higher layer protocols to sort the information. UDP 405 is preferable over TCP 403 when the data units are small, which saves processing time because of the minimal reassembly time. One of ordinary skill in the art would recognize that embodiments of the present invention can be practiced using either TCP 403 or UDP 405, as well as other equivalent protocols.

The next layer in the IP telephony architecture of FIG. 4A supplies the necessary IP telephony signaling and includes the H.323 protocol 407 and the Session Initiation Protocol (SIP) 409. The H.323 protocol 407, which is promulgated by the International Telecommunication Union (ITU), specifies a suite of protocols for multimedia communication. SIP 409 is a competing standard that has been developed by the Internet Engineering Task Force (IETF). SIP 409 is a signaling protocol that is based on a client-server model. It should be noted that both the H.323 protocol 407 and SIP 409 are not limited to IP telephony applications, but have applicability to multimedia services in general. In the system 100, SIP 409 is used to create and terminate voice calls over an IP network 103. However, it is understood that one of ordinary skill in the art would realize that the H.323 protocol 407 and similar protocols can be utilized in lieu of SIP 409. Above SIP 409 is the Session Description Protocol (SDP) 411, which provides information about media streams in the multimedia sessions, as to permit the recipients of the session description to participate in the session.

In an exemplary embodiment, SIP 409 includes addressing information corresponding to content supplied by the user. This address information may be present in a 18× response and used in a similar way to the 188 response code. This addressing, in an exemplary embodiment, may contain a Uniform Resource Identifier (URI)) or Uniform Resource Locator that provides information in human readable form.

As seen in FIG. 4B, an end terminal 115, as a subscriber device, communicates with a portal, as implemented by the platform 107. In step 451, the device 115 sends content to the portal, which in turn, generates a SIP URI (step 453). At this juncture, a SIP session is established to permit delivery of the content at a later point in time (step 455).

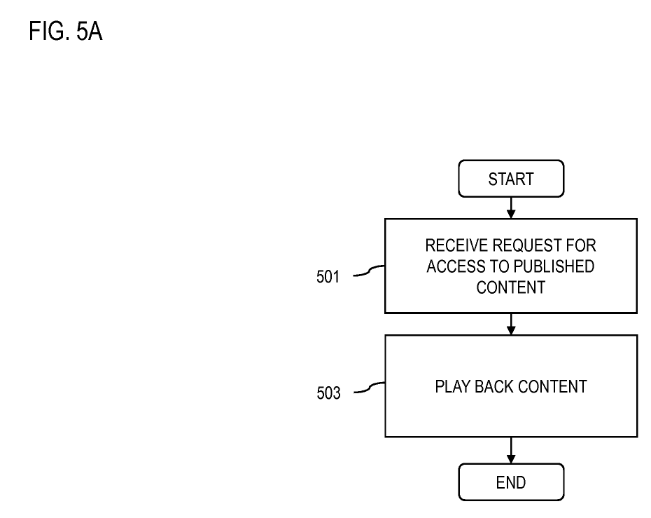

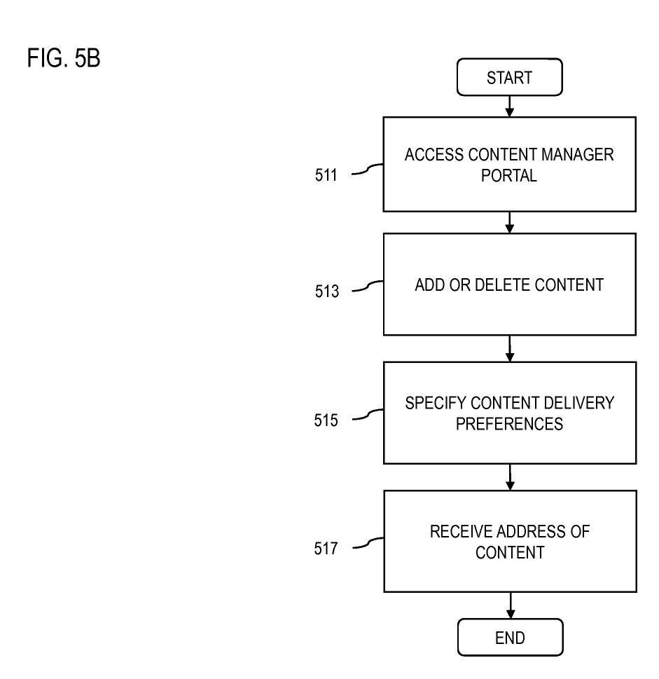

FIGS. 5A and 5B are flowcharts of processes for utilizing a content manager platform, according to various exemplary embodiments. Specifically, FIG. 5A shows a flowchart of a content playback process. In step 501, the content manager platform 107 receives a request to establish a media session for playing back published content. This request may, for instance, take the form of a request to initiate a media session using a specified address (e.g., SIP URI) for the content as described in the sample use cases above. In response to the request, the content manager platform 107 may direct the content delivery module 211 to deliver the content to the requesting communication device for playback (step 503). In certain embodiments, the content manager platform 107 may require authentication before delivering the content. It is contemplated that any type of authentication process (e.g., password protection, biometric security) can be employed to ensure that access is provided only to authorized users.

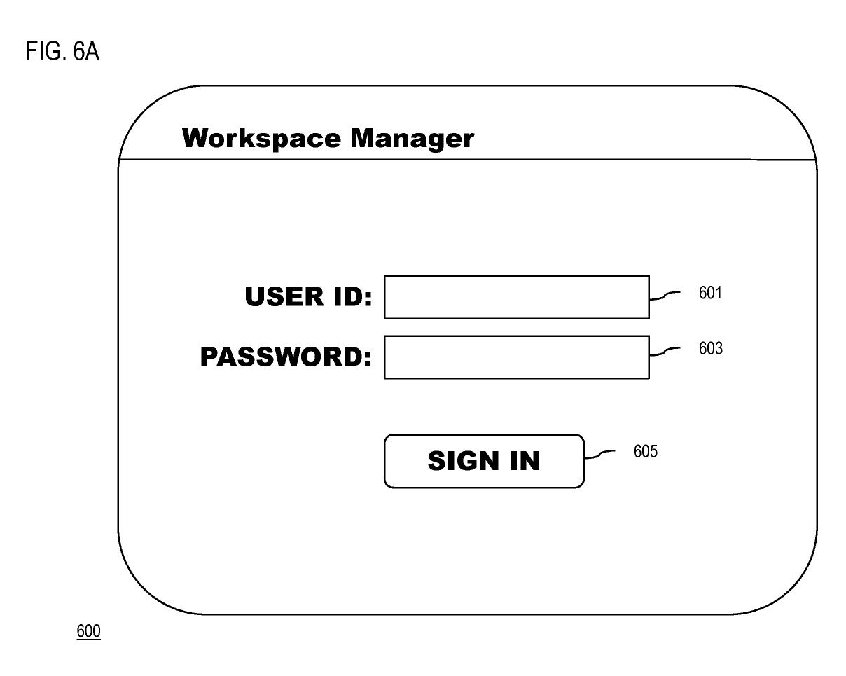

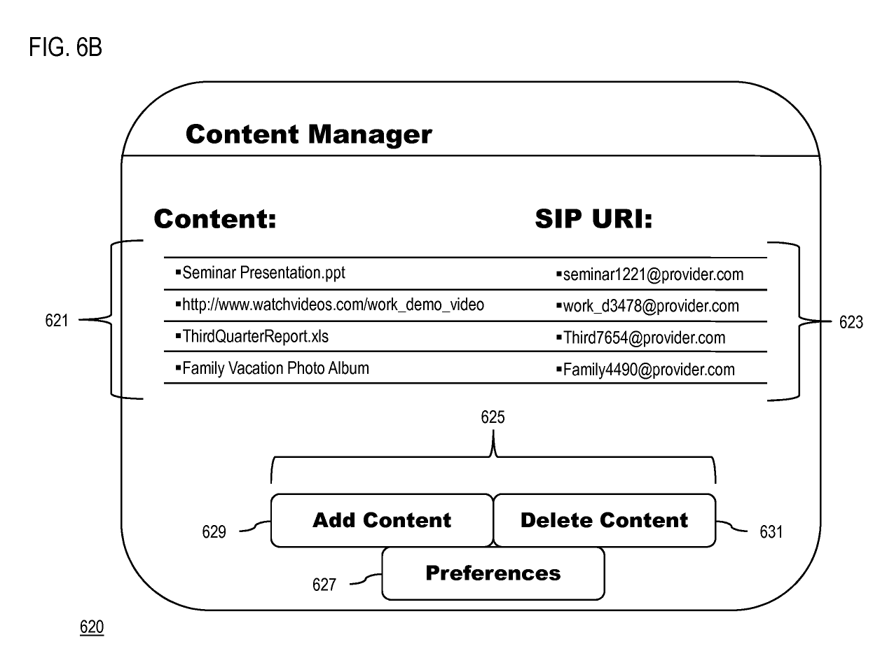

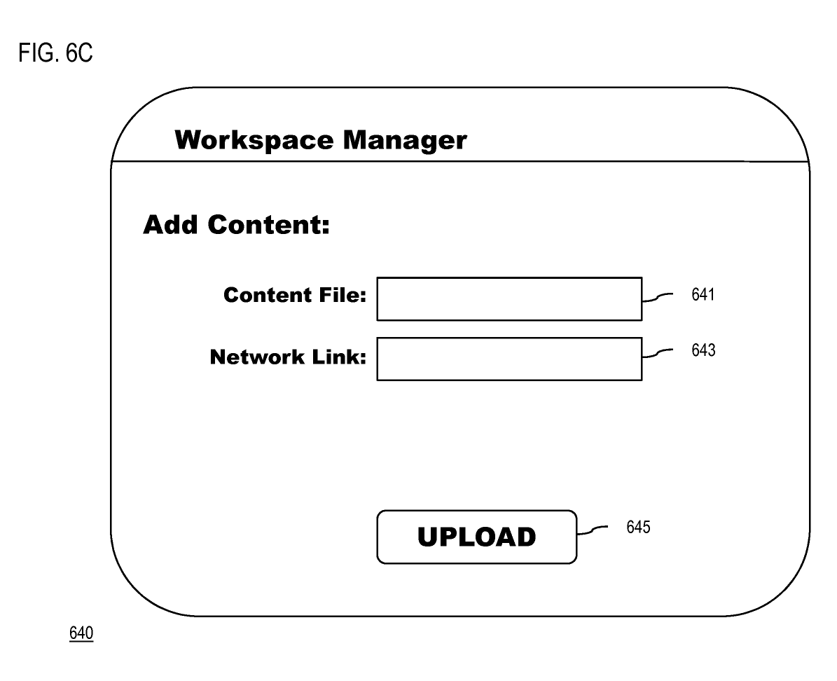

FIG. 5B illustrates a process for using the content manager platform, according to an exemplary embodiment. This process is also described with respect to FIGS. 6A-6C which depict exemplary graphical user interfaces for using a portal to access the functions of the content manager, according to various embodiments. As previously mentioned, the content manager platform 107 has connectivity to a host 117 that enables access to content manager platform 107 services, functions, and preferences via a graphical user interface or a web-based application. A user may access the graphical user interface portal using multimedia device 109, end terminal 111, or end terminal 115 (step 511). In exemplary embodiments, the user provides authentication credentials (e.g., password, biometric security) to access the services of the content manager platform 107. User interface 600 of FIG. 6A depicts an exemplary user interface screen that requests a user ID 601 and password 603 from the user. The user enters the requested user ID and password and selects the “Sign In” button 605 to proceed.

After entering valid authentication credentials, the user may access the portal to add or delete content (step 513) and/or specify content delivery preferences (step 515). In step 517, address of the content is received.

User interface 620 of FIG. 6B depicts an exemplary user interface screen that lists previously added content 621, the SIP URI 623 associated with the content, and available commands 625. The user may update content delivery preferences by selecting the preferences button 627. The user may then, for example, update preferences for how the content manager platform 107 converts user-specified content (e.g., media type, size, etc.) and preferences for when, to whom, and how (i.e., format) the content will be made available.

User interface 620 also includes commands for adding and deleting content stored in the content manager platform 107. To add content, the user may select the add content button 629, which may, for instance, bring up user interface 640 of FIG. 6C. As discussed previously, the user may add either the actual file of the content or a link to the content. Accordingly, user interface 640 of FIG. 6C includes both a content file field 641 and a network link field 643. The user may select the content file field 641 to add an electronic file or enter a network link to the content in the network link field 643. To complete the process, the user may then select the upload button 645.

To delete content, the user may, for example, select the content 621 as displayed in user interface 620 of FIG. 6B and then select the delete content button 631. Once deleted the content will no longer be available for access via its specified address (e.g., SIP URI).

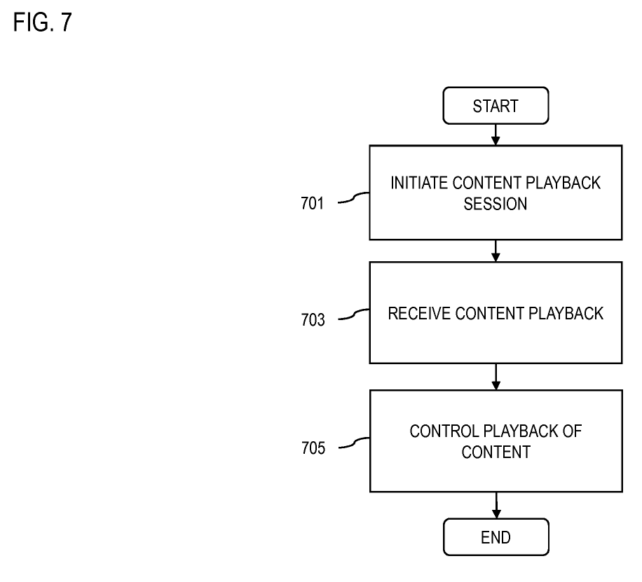

FIG. 7 is a flowchart of a process for playing back content during a media session, according to an exemplary embodiment. In this example, it is assumed that the desired content is available in the content manager platform 107 and the user has been provided the address (e.g., SIP URI) of the content. In step 701, the user initiates a media session with the specified address of the content. For example, in a network using IMS architecture for media delivery, the user establishes a media session (e.g., placing a call) with the SIP URI of the desired content. The user will then receive the requested content from the content manager platform 107 (step 703) as a media stream on the user's communication device. During playback of the content on the user's device, the user may control the media stream of the content via a control device such as a keypad (DTMF), keyboard, or similar device (step 705). In exemplary embodiments, playback controls include rewind, pause, and fast-forward. It is contemplated that other controls may be provided including skip, loop, playback speed, etc.

The processes described herein for managing content for access during a media session may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

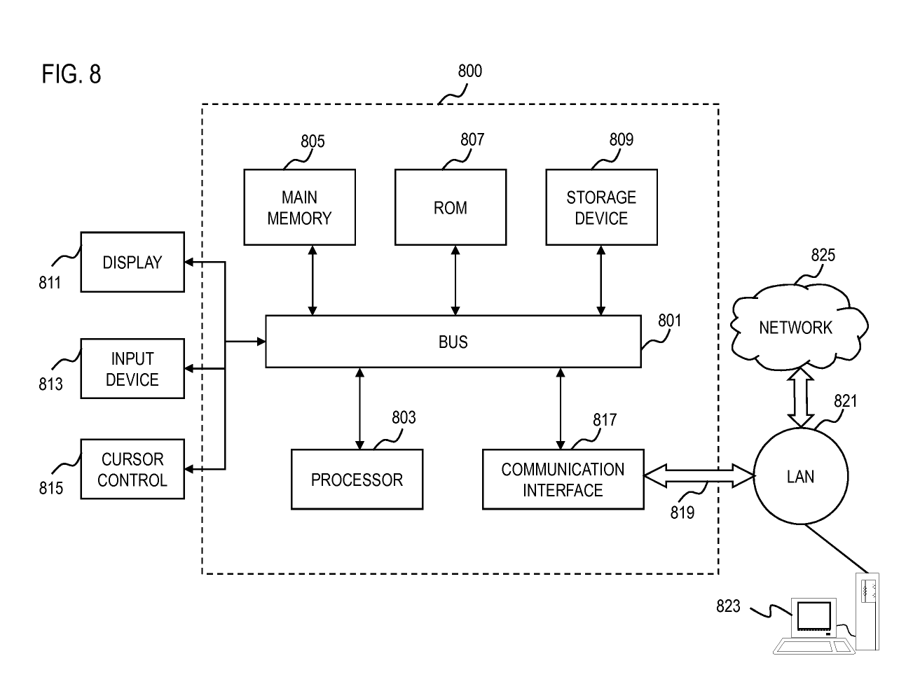

FIG. 8 illustrates computing hardware (e.g., computer system) upon which an embodiment according to the invention can be implemented. The computer system 800 includes a bus 801 or other communication mechanism for communicating information and a processor 803 coupled to the bus 801 for processing information. The computer system 800 also includes main memory 805, such as random access memory (RAM) or other dynamic storage device, coupled to the bus 801 for storing information and instructions to be executed by the processor 803. Main memory 805 also can be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving content or information relating to the content from a user over a data network; and
generating a message, according to an application layer protocol, specifying an address for subsequent retrieval, by the user, of the content over a communication session established over the data network utilizing the application layer protocol.

2. A method of claim 1, wherein the content includes at least one of an application document or a web-based media.

3. A method of claim 1, wherein the application layer protocol includes a Session Initiation Protocol.

4. A method of claim 3, wherein the address includes a SIP Uniform Resource Identifier.

5. A method of claim 1, wherein the user subscribes to a managed service for retrieval of the content.

6. A method of claim 1, further comprising:
selectively converting the content to a format compatible with the application layer protocol; and
publishing the converted content for subsequent access.

7. A method of claim 1, further comprising:
receiving a request to establish the communication session for playing back the published content based on the specified address; and
playing back the published content on one or more designated communication devices.

8. An apparatus comprising:
a database configured to store content or information relating to the content from a user over a data network; and
a content management module configured to generate a message, according to an application layer protocol, specifying an address for subsequent retrieval, by the user, of the content over a communication session established over the data network utilizing the application layer protocol.

9. An apparatus of claim 8, wherein the content includes at least one of an application document or a web-based media.

10. An apparatus of claim 8, wherein the application layer protocol includes a Session Initiation Protocol.

11. An apparatus of claim 8, wherein the address includes a SIP Uniform Resource Identifier.

12. An apparatus of claim 8, wherein the user subscribes to a managed service for retrieval of the content.

13. An apparatus of claim 8, further comprising:
a content conversion module configured to selectively convert the content to a format compatible with the application layer protocol; and
a content delivery module configured to publish the converted content for subsequent access.

14. An apparatus of claim 13, wherein the content delivery module is further configured to receive a request to establish the communication session for playing back the published content based on the specified address, and to play back the published content on one or more designated communication devices.

15. A system comprising:
a content manager configured to receive content from a user, and to output an address for the content according to an application layer protocol,
wherein the content manager is coupled to a multimedia system configured to communicate with a plurality of communication devices,
wherein the content manager is further configured to selectively convert the content to a format compatible with the application layer protocol, publish the converted content for access by the user, receive a request from the user to establish a media session for playing back the published content based on the specified address of the content, and play back the published content on one or more designated communication devices.

16. A system of claim 15, wherein the content includes at least one of an application document or a web-based media.

17. A system of claim 15, wherein the application layer protocol includes a Session Initiation Protocol.

18. A system of claim 15, wherein the address includes a SIP Uniform Resource Identifier.

19. A system of claim 15, wherein the user subscribes to a managed service for retrieval of the content.

20. A system of claim 15, wherein the media session includes a video conference session.
